(19) United States
(12) Patent Application Publication
(10) Pub. No.: US 2008/0138031 A1
(43) Pub. Date: Jun. 12, 2008

(54) Recording/reproducing apparatus, recording/reproducing method, and program

(75) Inventors: Tadashi Fujiwara, Kanagawa (JP); Hirofumi Murakami, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/998,367

(22) Filed: Nov. 29, 2007

(30) Foreign Application Priority Data
Dec. 11, 2006 (JP) P2006-333183

(51) Int. Cl. H04N 5/93

(52) U.S. Cl. 386/52

(57) ABSTRACT

A recording/playback apparatus includes a recording/playback unit configured to perform data recording/playback on a recording medium permitting random access, a command inputting unit configured to input a series of predetermined commands transmitted from an external edit instructing device, a corresponding processing executing unit configured to execute processing including at least control of data recording/playback performed by the recording/playback unit, and a control unit configured to control the corresponding processing executing unit in response to an edit recording stop command included in the series of predetermined commands, so that the edit instructing device recognizes that the recording/playback unit is at least not in a stop state during a predetermined response period which begins after input of the edit recording stop command and so that data recording as edit recording being performed by the recording/playback unit is stopped at a predetermined timing within the predetermined response period.

### CROSS REFERENCES TO RELATED APPLICATIONS

The present invention contains subject matter related to Japanese Patent Application JP 2006-333183 filed in the Japanese Patent Office on Dec. 11, 2006, the entire contents of which are incorporated herein by reference.

### BACKGROUND OF THE INVENTION

1. Field of the Invention

The present invention relates to recording/playback apparatuses which are preferable, for example, for editing in which new data is additionally recorded on a recording medium having stored thereon data such as video/audio data as editing source data (assemble editing) and to recording/playback methods for the recording/playback apparatuses. The present invention also relates to programs executed by such recording/playback apparatuses.

2. Description of the Related Art

In professional-use video camera apparatuses and peripheral editing devices (video devices) used in industries such as the broadcasting industry, for example, tape-shaped recording media (tape recording media) have long been used for recording video information obtained through image capturing. However, with the recent increase in storage capacity of optical disc-shaped storage media (disc storage media) to a level sufficient for professional photographing operations and with the advance of compression encoding techniques, professional-use video devices using optical disc recording media have been developed. This development allows users to enjoy technical advantages of disc recording media even in the field of professional-use video devices, such as preservability of recorded data quality and miniaturization of recording media for portability.

In general, when video information stored in storage media such as optical disc recording media that permit random access is edited, video data serving as an editing source material is loaded to a hard disk drive (HDD) or the like of a computer by copying, for example. Then, using application software for editing, operations such as connecting arbitrary sections (scenes) extracted from the stored video information are performed. Such an editing scheme is called nonlinear editing. Nonlinear editing is suitable for an environment where video information is digitized and stored in a storage medium which permits random access. In addition, nonlinear editing allows general users to easily perform editing operations and enjoy the amusement aspect of editing. Thus, consumer application software for video information editing is manufactured under the assumption that it will be used for nonlinear editing.

However, in industries which deal with video images, linear editing is often performed. The reasons for this are as follows: Tape recording media have mainly been used as recording media for editing, and thus linear editing can readily be performed; Editing has to be performed in a short time, for example, to meet a program broadcasting start time. Since highly experienced technicians tend to perform linear editing operations very intuitively and can quickly produce an editing result, they have long been appreciated in the video industry.

Under the above circumstances, professional-use video devices for editing that are configured for use in linear editing have been in widespread use for a long time.

For linear editing, assemble editing is often performed. In assemble editing, desired scenes are extracted from video information stored in different tape recording media (video tape cassettes) and recorded onto one tape cassette called a master tape. For example, when dubbing from a certain tape cassette to a master tape is performed, data corresponding to a desired scene and a little extra time from the end of the scene is dubbed onto the master tape. When dubbing from another tape cassette to the master tape is performed, the master tape is rewound to the end position of the previously dubbed scene, and from this position a subsequent scene is dubbed.

### SUMMARY OF THE INVENTION

Under the above circumstances, even if recording/playback devices compatible with storage media which permit random access (random access storage media) such as optical disc storage media are implemented as recording/playback devices for editing, users who use professional video devices still want to perform linear editing such as assemble editing in the same fashion as they have long practiced.

In addition, since such users usually own peripheral devices for tape recording media, they want to employ recording/playback devices for editing compatible with random access storage media in combination with their peripheral devices.

The present invention has been made in view of the above circumstances. Accordingly, there is a need for a technique which allows linear editing (assemble editing) to be normally performed even in a system in which a recording/playback device for editing compatible with random access storage media is implemented in combination with a commonly-used peripheral device which is not intended to be used with random access storage media.

Accordingly, a recording/playback according to an embodiment of the present invention includes a recording/playback unit configured to perform data recording/playback on a recording medium permitting random access, a command inputting unit configured to input a series of predetermined commands transmitted from an external edit instructing device so that a result of data editing performed according to a predetermined editing scheme is obtained as recorded data on the storage medium, a corresponding processing executing unit configured to execute processing including at least control of data recording/playback performed by the recording/playback unit, so that an operation corresponding to a command input to the command inputting unit is performed, and a control unit configured to control the corresponding processing executing unit in response to an edit recording stop command included in the series of predetermined commands, the edit recording stop command instructing stopping of edit recording in which the recording/playback unit records data to be added to an editing material on the storage medium, so that the edit instructing device recognizes that the recording/playback unit is at least not in a stop state during a predetermined response period which begins after input of the edit recording stop command and so that data recording as the edit recording being performed by the recording/playback unit is stopped at a predetermined timing within the predetermined response period.

In the above recording/playback apparatus, operations such as recording/playback on a random access recording medium are performed in response to the series of commands output from the external edit instructing device, so that data recording as edit recording is performed on the recording medium.

In processing corresponding to the edit recording stop command which instructs stopping of edit recording in which the recording/playback unit records data to be added to an editing material on the recording medium, the edit instructing device recognizes that the recording/playback unit is at least not in a stop state during a predetermined time period (response period) which begins after input of the edit recording stop command, and data recording as the edit recording being performed by the recording/playback unit is stopped at a predetermined timing within the predetermined response period.

For example, there is a type of edit instructing device for use in editing using a tape recording medium which is configured to output commands under the assumption that the tape recording medium is kept running after recording of data to be added (additional data) for editing (edit recording) is stopped. The recording/playback apparatus according to an embodiment of the present invention employs this configuration to causes the edit instructing device to recognize that recording/playback (running of the tape recording medium) has not been stopped since recording of additional data was stopped, even if the recording/playback apparatus is actually in a stop state.

Thus, according to the present invention, the edit instructing device recognizes that the recording/playback apparatus is in a state other than recording/playback stop state even after edit recording is actually stopped. Therefore, normal command output from the edit instructing device and corresponding operations performed by the recording/playback apparatus can be realized even after the edit recording is actually stopped. That is, editing operations corresponding to edit instructions from the edit instructing device can be normally performed, even in a system where a recording/playback apparatus compatible with random access storage media is implemented in combination with an edit instructing device for use with a storage medium such as a tape recording medium which does not permit random access.

### BRIEF DESCRIPTION OF THE DRAWINGS

FIG. 1 illustrates an example of a configuration of a disc recording/playback apparatus according to an embodiment of the present invention;

FIG. 2 illustrates an example of processing procedure to be performed by an edit instructing device for automatically executing assemble editing;

FIG. 3 illustrates an example of operation results obtained when a recorder compatible with random access storage media is controlled by an edit instructing device for the automatic execution of assemble editing;

FIG. 4 illustrates another example of operation results obtained when a recorder compatible with random access storage media is controlled by an edit instructing device for the automatic execution of assemble editing; and

FIGS. 5A and 5B illustrate an example of a processing procedure to be performed by an edit instructing device for the automatic execution of assemble editing and an example of a corresponding processing procedure to be performed by a disc recording/playback apparatus according to an embodiment of the present invention, respectively.

### DESCRIPTION OF THE PREFERRED EMBODIMENTS

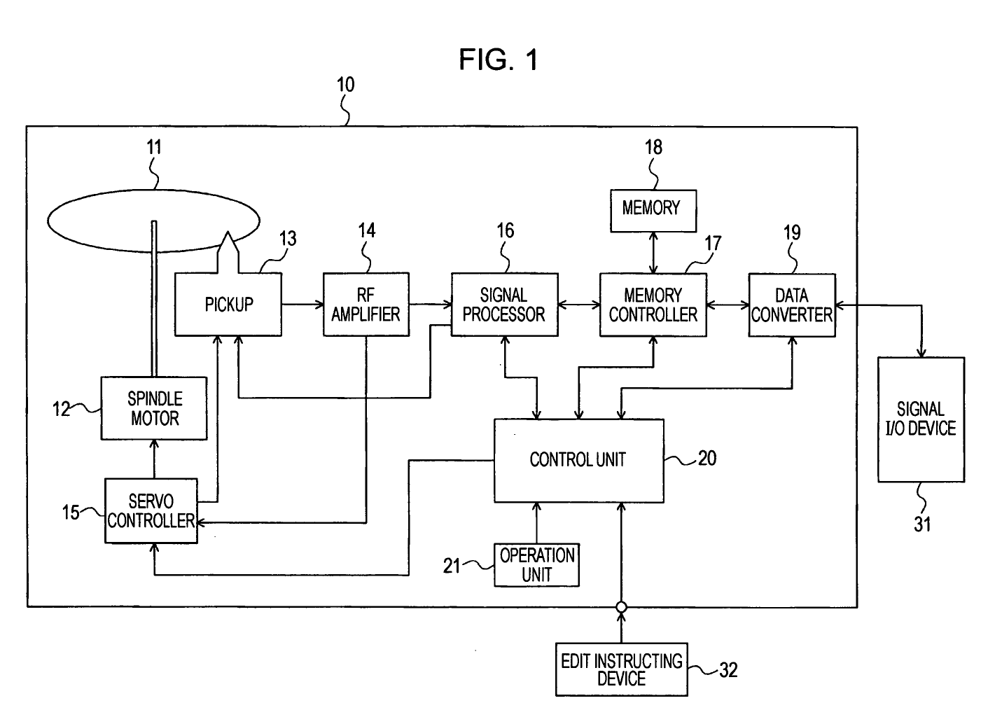

FIG. 1 illustrates an example of a configuration of a disc recording/playback apparatus according to an embodiment of the present invention. A disc recording/playback apparatus 10 has a configuration of a recording control device according to the present embodiment. The disc recording/playback apparatus 10 also has a function as an editing device for editing video/audio information containing, for example, video information and audio information whose playback times is synchronized.

In FIG. 1, a spindle motor 12 rotates an optical disc 11 at a constant linear velocity (CLV) or a constant angular velocity (CAV), on the basis of a spindle motor drive signal supplied from a servo controller 15.

A pickup 13 outputs laser light for recording on the basis of a recording signal supplied from a signal processor 16 to record signals on the optical disc 11. The pickup 13 irradiates laser light onto the optical disc 11 and converts reflected light from the optical disc 11 into an electric current signal. The pickup 13 then supplies the electric current signal to an RF (radio frequency) amplifier 14. An irradiation position of laser light is controlled by a servo control signal supplied from the servo controller 15 to the pickup 13.

The RF amplifier 14 generates a focus error signal, a tracking error signal, and a playback signal, on the basis of the electric current signal supplied from the pickup 13. The tracking error signal and the focus error signal are input to the servo controller 15, and the playback signal is input to the signal processor 16.

The servo controller 15 performs servo control such as focus servo control and tracking servo control. For example, the servo controller 15 generates a focus servo control signal and a tracking servo control signal on the basis of the focus error signal and the tracking error signal, respectively, supplied from the RF amplifier 14, and outputs the generated signals to an actuator (not shown) of the pickup 13. The servo controller 15 also generates a spindle motor drive signal for driving the spindle motor 12 to perform spindle servo control for rotating the optical disc 11 at a predetermined rotational speed.

In addition, the servo controller 15 performs sled control in which the pickup 13 is moved in a radial direction of the optical disc 11 to adjust the irradiation position of laser light.

In reading of signals (data) from the optical disc 11, a signal readout position (address) is specified by a control unit 20. Control of laser irradiation position on the optical disc 11 including the sled control is performed so that signals are read from a specified readout position.

In recording, the signal processor 16 performs recording modulation on recording data supplied from a memory controller 17 to generate a recording signal and supplies the recording signal to the pickup 13. In playback, the signal processor 16 performs demodulation on a playback signal from the RF amplifier 14 to obtain playback data and supplies the playback data to the memory controller 17.

The memory controller 17 writes recording data supplied from a data converter 19, to a memory 18 for temporary storage as necessary, which will be described below. The memory controller 17 also reads out the temporarily-stored recording data and supplies the read data to the signal processor 16. In addition, the memory controller 17 writes playback data transferred from the signal processor 16, to the memory 18 for temporary storage as necessary. The memory controller 17 also reads out the temporarily stored data and supplies the read data to the data converter 19.

The data converter 19 compression-encodes information input from a signal input/output device 31 in a predetermined compression encoding format and outputs the compression-encoded information to the memory controller 17 as necessary. Such information may be, for example, video/audio information corresponding to a captured image and collected sound, which is obtained by photographing/recording using a video camera and stored in a storage medium in the video camera, or may be video/audio information which is played back from a storage medium (not shown) by another video device.

The data converter 19 also demodulates (expands) video/audio playback data transferred from the memory controller 17 using a demodulation scheme corresponding to the compression encoding. The data converter 19 then converts the demodulated video/audio playback data into video/audio signals in a predetermined signal format and outputs the signals to the signal input/output device 31.

The control unit 20 controls the servo controller 15, the signal processor 16, the memory controller 17, and the data converter 19 to execute a recording/playback operation.

The control unit 20 has a configuration as, for example, a microcomputer, and thus includes a CPU (central processing unit) and a storage unit such as a ROM (read-only memory), a RAM (random access memory), and a flash memory.

An operation unit 21 includes various operation components mounted to the disc recording/playback apparatus 10 and an operation signal output portion which generates an operation signal in response to an operation performed on the operation components and outputs the operation signal to the control unit 20 (CPU). The control unit 20 executes necessary control processing so that an operation corresponding to the input operation signal is performed.

In the above configuration, a flow of a recording signal in recording of a video/audio signal (data), for example, is as follows. First, data for recording (recording data) is obtained from the signal input/output device 31. Then, the video/audio signal input as recording data undergo processing such as compression encoding in the data converter 19. After being temporarily stored in the memory 16 by the memory controller 17, the video/audio signal is output to the signal processor 16. The recording data input to the signal processor 16 undergoes recording modulation and is then output to the pickup 13 as a recording signal. In accordance with the input recording signal, the pickup 13 irradiates laser light to record data on the optical disc 11.

In playback, a signal recorded on the optical disc 11 is read by the pickup 13 as an electric current signal. The read electric current signal is converted by the RF amplifier 14 into a binary playback signal and modulated by the signal processor 16 by a modulation scheme corresponding to the recording modulation. The demodulated signal is transferred to the memory controller 17 as video/audio playback data. The memory controller 17 may output the received playback data to the data converter 19 through the memory 18. The playback data input to the data converter 19 is expanded as necessary by an expansion scheme corresponding to the compression encoding. The expanded data is output to the signal input/output device 31 as a video/audio signal in a predetermined format.

The data which is recorded and played back on and from the optical disc 11 is managed by a predetermined file system. The control unit 20 controls the file system in accordance with a program.

The disc recording/playback apparatus 10 can be connected to an edit instructing device 32.

In the field of professional-use video devices, an editing device such as the disc recording/playback apparatus 10 according to the present embodiment is called a recorder, for example, and the edit instructing device 32 is called an editor, for example, as a type of peripheral device for a recorder.

The edit instructing device 32 is manufactured under the assumption that it is to be used with a recorder compatible with magnetic tape recording media, for example, which has already been in widespread use before the introduction of the disc recording/playback apparatus 10 of the present embodiment. In addition, the edit instructing device 32 is configured to perform operations for executing recording/playback according to a predetermined editing technique such as linear editing (e.g., assemble editing) using the recorder and to output commands to the recorder in accordance with the operations.

For example, when the control unit 20 receives a command transmitted from the edit instructing device 32, the control unit 20 performs control necessary for executing an operation corresponding to the received command.

As described above, the edit instructing device 32 is used in combination with a recorder compatible with magnetic tape recording media. In the following, a case where assemble editing, which is one of typical linear editing techniques, is performed using the edit instructing device 32 and a recorder compatible with magnetic tape recording media will be described.

As described above, assemble editing is an editing technique in which video data is dubbed to a master tape, i.e., video data is additionally recorded over the master tape which is supposed to be a magnetic tape recording medium. During the assemble editing an unnecessary portion of video data which has already been recorded in the master tape is overwritten with newly dubbed video data, such that an editing result is time-sequentially created.

Although editing can be performed without the edit instructing device 32 by operating the operation components of the recorder, for example, the use of the edit instructing device 32 enhances operability in editing. Further, when the edit instructing device 32 is used, an in-point (additional recording (dubbing) start point in assemble editing) or the like is set beforehand, and operations for automatically executing editing are performed by the edit instructing device 32. This allows the edit instructing device 32 to automatically control operations for editing to be performed in the disc recording/playback apparatus 10.

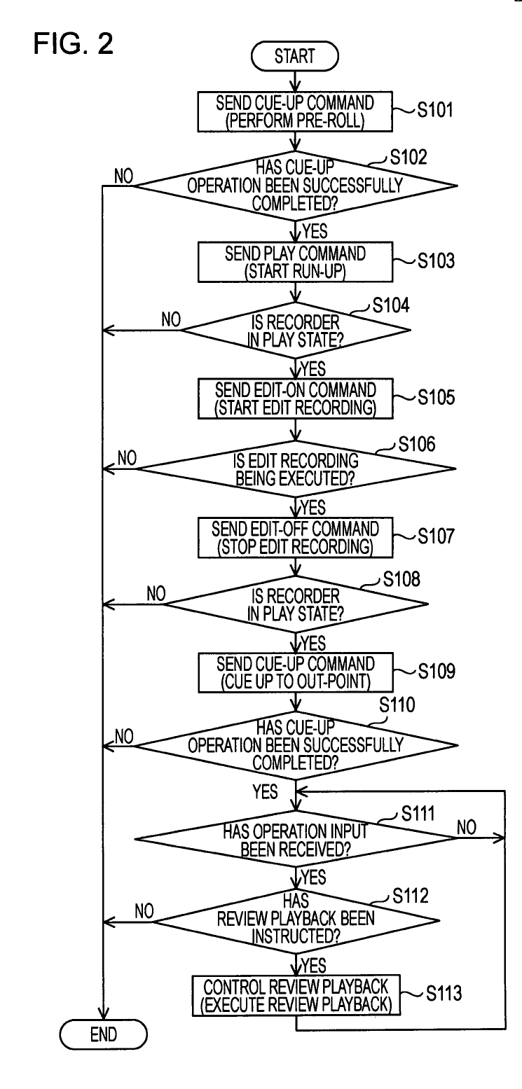

FIG. 2 illustrates a processing procedure performed by the edit instructing device 32 when assemble editing is automatically executed. Note that a recorder connected to the edit instructing device 32 is not the disc recording/playback apparatus 10 according to the present embodiment but a recording/playback apparatus for performing recording/playback on a magnetic tape recording medium, which has already been in widespread use.

When initiating the processing procedure illustrated in FIG. 2, the edit instructing device 32 notifies the recorder that the automatic execution of assemble editing is to be started. Thus, when the processing procedure is initiated, the recorder recognizes that operations to execute at this time and thereafter correspond to the automatic execution of assemble editing. In addition, prior to the execution of the processing procedure, items such as an in-point and an out-point necessary for editing are set. In assemble editing, an in-point refers to a recording start position of video data to be dubbed (additional video data), in video data which has originally been recorded on a recording medium (magnetic tape recording medium in this case) as an editing source material (a base for editing). An out-point refers to a recording end position of the additional video data.

Referring to FIG. 2, at Step S101, for the first process for controlling automatic execution of assemble editing, the edit instructing device 32 sends the recorder a cue-up command (command information which instructs a cue-up operation). When receiving this cue-up command, the recorder executes a cue-up operation as pre-roll, which is not illustrated in the figure. Pre-roll refers to an operation in which a tape recording medium is rewound to a position at a predetermined distance back from the in-point (pre-roll point).

Then, at Step S102, the edit instructing device 32 determines whether or not the cue-up operation of the recorder performed in response to the cue-up command has been successfully completed. If the cue-up operation has been successfully completed in the recorder, the recorder sends the edit instructing device 32 a status notification information indicating the successful completion of the cue-up operation (successful cue-up), for example, as a response to the cue-up command. When receiving the notification, the edit instructing device 32 determines that the cue-up operation has been successfully completed in Step S102, and the processing procedure proceeds to Step S103.

On the other hand, there may be a case where the cue-up command has not been received by the recorder, or, if received, the cue-up operation corresponding to the cue-up command has not been normally completed. In such a case, the recorder may not send a response to the edit instructing device 32 within a predetermined time period or may send the edit instructing device 32 a notification as a response indicating an error in the cue-up operation. When detecting such a response, the edit instructing device 32 determines that the cue-up operation has not been successfully completed (failed) in Step S102. In this case, the processing procedure is terminated, i.e., the automatic execution of assemble editing is interrupted.

At Step S103, the edit instructing device 32 transmits a play command for instructing playback of the magnetic tape recording medium (normal running of the magnetic tape recording medium). In response to the play command, the recorder initiates playback from the pre-roll point. In order to appropriately start recording of additional video data from the in-point, it is necessary to ensure stable running of the magnetic tape recording medium before the in-point is reached and to start recording of the additional video data at a time point when the in-point is reached. Running a magnetic tape recording medium from a position back from the in-point is called run-up. The playback of the magnetic tape recording medium in response to the play command in Step S103 is performed for run-up. The pre-roll described above is an operation to be performed to save time for running the magnetic tape recording medium for run-up.

After sending the play command, the edit instructing device 32 determines whether or not the recorder is in a play state, at Step 104. Specifically, the edit instructing device 32 determines whether or not the recorder is normally running the magnetic tape recording medium in response to the play command sent in Step 103.

When the recorder is normally running the magnetic tape recording medium for run-up in response to the play command, the recorder periodically sends the edit instructing device 32 status notification information indicating status of the recorder (“play” status in this case). This “play” status does not only indicate that a playback operation is being performed but also indicates that the recorder is running the magnetic tape recording medium regardless of whether the recorder is running the recording medium for recording or playback.

As described above, when a notification of “play” status is transmitted from the recorder, the edit instructing device 32 obtains a positive determination result, and the processing procedure proceeds to Step S105. On the other hand, if no response has been transmitted from the recorder within a predetermined time period after the transmission of the play command, or if a response indicating a certain error is transmitted, the edit instructing device 32 receives a negative determination result in Step S104. In this case, the processing procedure is terminated.

If the recorder is normally running the edit instructing device 32 for run-up, the recording position of the magnetic tape recording medium reaches the in-point at a certain timing. At Step S105, the edit instructing device 32 sends the recorder an edit-on command at a timing when the in-point is reached. The recorder loads a source signal of additional video data while running the magnetic tape recording medium. Then, in response to the edit-on command, the recorder initiates recording of the source signal of the additional video data (additional video signal) on the magnetic tape recording medium. That is, the edit-on command in this case is a command for instructing start of recording of the additional video data as assemble editing (edit recording).

At Step S106, the edit instructing device 32 determines whether or not the recorder is executing the edit recording described above in response to the edit-on command transmitted in Step S105. When the edit recording is normally initiated, the recorder periodically sends the edit instructing device 32 status notification information indicating that edit recording is being executed (“edit recording” status).

When the notification of “edit recording” status is transmitted from the recorder, the edit instructing device 32 obtains a positive determination result in Step S106, and the processing procedure proceeds to Step S107. On the other hand, if no response has been transmitted within a predetermined time after the transmission of the edit-on command in Step S105, or if a response indicating an error or notification of status other than “edit-recording” status is transmitted from the recorder, the edit instructing device 32 obtains a negative determination result and thus terminates the processing procedure.

At Step S107, the edit instructing device 32 sends an edit-off command for stopping the currently executed recording of additional video data at a timing when the out-point of the additional video data on the magnetic tape recording medium is reached.

When receiving the edit-off command, the recorder stops an operation for recording the additional video signals on the magnetic tape recording medium. However, the recorder continues to run the magnetic tape recording medium. For example, if both the running of the magnetic tape recording medium and the recording of additional video signals are stopped at the same time, an abnormality may occur in the recording on the magnetic tape recording medium around the out-point. Thus, the magnetic tape recording medium is kept running after the out-point is reached to avoid occurrence of such an abnormality.

After transmitting the edit-off command in Step S107, the edit instructing device 32 determines whether or not the recorder is in the play state in Step S108. When the recorder is running the magnetic tape recording medium after the recording of the additional video signals is stopped, as described above, the recorder notifies the edit instructing device 32 of the “play” status. When receiving the notification of “play” status, the edit instructing device 32 obtains a positive determination result in Step S108, and the processing procedure proceeds to Step S109. On the other hand, there may be a case where a notification or a response other than “play” status signal is transmitted, since, for example, the recording of the additional video signals is not completed, and the notification of “edit-recording” status has been continuously transmitted. In addition, a response indicating an error or a status notification indicating that the running of the magnetic tape recording medium is stopped may be transmitted. In such a case, the edit instructing device 32 obtains a negative determination result in Step S108 and thus terminates the processing procedure.

At Step S109, the edit instructing device 32 transmits a cue-up command for instructing the recorder to rewind the magnetic tape recording medium to a position corresponding to the out-point of the additional video signals. When receiving the cue-up command, the recorder rewinds the magnetic tape recording medium so that the playback position is set to a position corresponding to the out-point.

At Step S110, the edit instructing device 32 determines whether or not the cue-up operation of the recorder corresponding to the cue-up command transmitted in Step S109 has been successfully completed. Also in this case, if the cue-up operation has been successfully completed, the recorder sends the edit instructing device 32 a notification of the successful completion of the cue-up operation as a response. Thus, the edit instructing device 32 obtains a positive determination result in Step S110, and the processing procedure proceeds to Step S111. On the other hand, if no response notifying successful completion of the cue-up operation has been transmitted within a predetermined time period, the processing procedure is terminated.

The rewinding of the magnetic tape recording medium to the out-point is performed taking into account that recording of another additional video data (dubbing) may be performed immediately after the current edit recording. If the magnetic tape recording medium has been rewound to the out-point, it is possible to determine an in-point for the subsequent dubbing by playing back the magnetic tape recording medium backward from the out-point. That is, the rewinding to the out-point enables an efficient operation for determining the in-point.

At Step S111, the edit instructing device 32 waits for an operation input after the edit recording is completed. If the edit instructing device 32 receives an operation input, the processing procedure proceeds to Step S112.

At Step S112, the edit instructing device 32 determines whether or not the received operation input instructs playback of a review. If the operation input does not instruct review playback, i.e., the edit instructing device 32 receives a negative determination result, the edit instructing device 32 skips to another processing corresponding to the received operation input. On the other hand, if the operation input instructs review playback, i.e., the edit instructing device 32 obtains a positive determination result, the processing procedure proceeds to Step S113.

At Step S113, the edit instructing device 32 controls the recorder in response to the review playback instruction so that the review playback is automatically executed. Review playback herein means playing back the magnetic tape recording medium to check an editing result after edit recording in assemble editing is completed.

For the control of review playback in Step S113, the edit instructing device 32 instructs the recorder to rewind the magnetic tape recording medium to the in-point (cue-up). When the rewinding to the in-point is completed, the edit instructing device 32 instructs the recorder to perform playback from the in-point to the out-point. In response to the instruction, the recorder performs review playback by rewinding the magnetic tape recording medium to the in-point and performing playback to the out-point. Once the review playback is completed, the processing procedure returns to Step S111.

As can be understood from the above description using FIG. 2, the edit instructing device 32 is configured to control a recorder which performs recording/reproducing on a magnetic tape recording medium to execute linear editing including at least assemble editing. In other words, the edit instructing device 32 is manufactured only under the assumption that it is to be used in combination with a recorder compatible with magnetic tape recording media, which have been in widespread use before the introduction of a recorder compatible with random access recording media, such as the disc recording/playback apparatus 10 according to the present embodiment.

Now, it is assumed that a professional-use video device compatible with random access recording media such as the disc recording/playback apparatus 10 according to the present embodiment is introduced. Often, users have already owned a number of video devices compatible with magnetic tape recording media. Even if a user has not previously owned such video devices, he or she may desire to enjoy the advantages of random access recording media, which have been widespread and standardized, by replacing or using his or her previously owned video device. Such a user may purchase and install professional video devices compatible with random access recording media which are necessary to this end.

Consequently, the user may desire to use a newly installed video device compatible with random access storage media in the usage environment of a video device compatible with magnetic tape recording media that the user has already owned and implemented, using the same operation procedure as used for the already-implemented video device for magnetic tape recording media.

When the user's desire described above is considered within the framework of the interaction between a recorder for use with random access recording media (recorder for random access recording media) and the edit instructing device 32, it is preferable that editing is performed using a recorder for random access recording media and the edit instructing device 32, which has been standardized and is compatible with magnetic tape recording media, through the same operation procedure as has already been used.

Under the above circumstances, it is necessary to enable a recorder for random access recording media to operate in combination with the edit instructing device 32. In other words, it is necessary that the recorder for random access recording media is configured to perform operations in accordance with instructions transmitted from the edit instructing device 32.

Thus, the recorder for random access recording media operable with the edit instructing device 32 may be provided with a connecter compatible with the physical layer of a communication standard with which the edit instructing device 32 complies and hardware components such as a signal input/output circuit. In addition, a program capable of interpreting an input command and executing processing corresponding to the command may be installed in the recorder for random access recording media as functions corresponding to a hierarchical layer which is higher than the physical layer.

However, as described above, since the edit instructing device 32 is manufactured under the assumption that it is to be used in combination with a recorder for magnetic tape recording media, the content of a command and a command output procedure are based on the assumption that the recorder drives a magnetic tape recording media, as described above with reference to FIG. 2. Thus, if the recorder for random access recording media operable with the edit instructing device 32 is configured to simply execute an operation corresponding to the content of a command output from the edit instructing device 32, the following failure may occur.

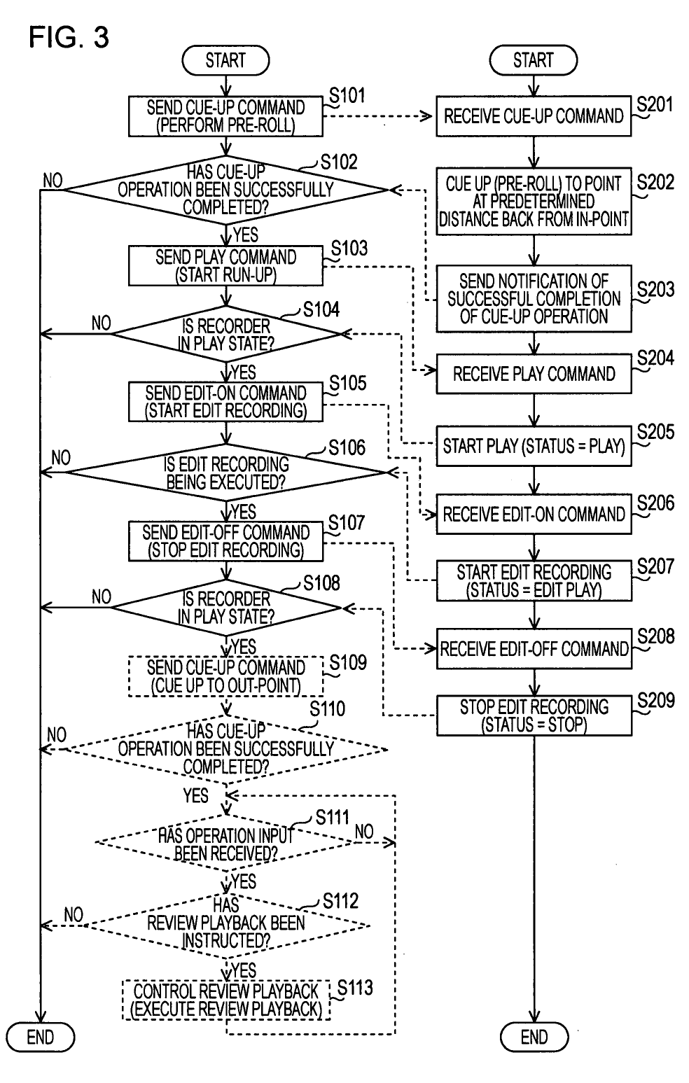

FIG. 3 illustrates a processing procedure to be performed in a case where the edit instructing device 32 executes control for carrying out assemble editing similarly to the case illustrated in FIG. 2. However, in this case, the edit instructing device 32 performs the control on a recorder for random access recording media having a correspondence function (simple correspondence function) in which the recorder simply executes an operation corresponding to the content of a command. A flowchart shown in the left hand side of FIG. 3 shows a processing procedure performed by the edit instructing device 32 which is similar to the processing procedure illustrated in FIG. 2, and a flowchart shown in the right-hand side of FIG. 3 illustrates a processing procedure to be performed by the recorder for random access recording media having the above simple correspondence function, in response to command from the edit instructing device 32.

In FIG. 3, the edit instructing device 32 sends the recorder a cue-up command at Step S101, and the recorder receives the cue-up command at Step S201. In response to the received cue-up command, the recorder performs a cue-up operation as pre-roll at Step S202. Since this pre-roll operation is performed on a random access recording medium, an operation such as rewinding of a magnetic tape recording medium is not performed. Instead, for example, the address of a data position located preceding the data position as an in-point by a distance corresponding to a playback time necessary for pre-roll is calculated and stored. When this pre-roll operation is completed, the recorder sends the edit instructing device 32 a notification of successful completion of the cue-up operation as a response.

When receiving the response notifying the successful completion of the cue-up operation, the edit instructing device 32 determines that the cue-up operation has been successfully completed in Step S102 and sends the recorder a play command at Step S103.

The recorder receives the play command at Step S204 and initiate playback at Step S205. Specifically, the recorder starts running the magnetic tape recording medium from the pre-roll position for run-up. Once the playback is initiated, the recorder periodically sends the edit instructing device 32 a notification of “play” status. On the basis of the notification of “play” status, the edit instructing device 32 determines that the recorder is in a play state in Step S104, and the processing procedure proceeds to Step S105. At Step S105, the edit instructing device 32 sends the recorder an edit-on command at a timing when the current recording position on the magnetic tape recording medium reaches the in-point.

The recorder receives this edit-on command at Step S206. In response to the edit-on command, the recorder initiates an edit recording (recording of additional video data), During the execution of the edit recording, the recorder notifies the edit instructing device 32 of “edit-play” status indicating that edit recording is in progress. By receiving the status information, the edit instructing device 32 obtains a positive determination result in Step S106, and the processing procedure proceeds to Step S107.

At Step S107, the edit instructing device 32 sends the recorder an edit-off command for stopping the recording of the additional video data at a timing when the recording position reaches an out-point set in the additional video data. At Step S208, the recorder receives the edit-off command. Then, at Step S209, the recorder stops the recording of the additional video data on the recording medium (edit recording) in response to the edit-off command.

If the recorder used in this procedure is compatible with common magnetic tape recording media, a magnetic tape recording medium is kept running for a predetermined time period even after the recording of additional video data is completed, as described above with reference to FIG. 2. This indicates that the recorder sends the edit instructing device 32 a notification of “play” status after the completion of the edit recording, and thus the edit instructing device 32 can obtain a positive determination result in Step S108. As is understood by those skilled in the art, when data on a magnetic tape recording medium is accessed, a running tape-shaped recording area is scanned using a recording/playback head by a predetermined scanning scheme. Thus, even if only the recording of additional video data (edit recording) is completed as in the above case, the running of the magnetic tape recording medium, i.e., playback, can be continued as long as the magnetic tape recording medium is kept running, regardless of whether or not a signal has been recorded at a position forward from the end position of the additional video data.

On the other hand, the recorder implemented in the processing procedure described with reference to FIG. 3 is compatible with random access recording media such as optical disc recording media. In general, data recorded on a random access recording medium is managed in unit of data file in a file system, for example. In the case of assemble editing, the end point of recorded additional video data is managed as the end of a file. Taking this into account, in the edit recording of Step S209 in FIG. 3, recording is performed to the end of a file corresponding to the additional video data. Thus, no data to be subsequently played back from the end position is present. Therefore, the recorder sends the edit instructing device 32 of status notification information indicating stop of running of the magnetic tape recording medium (“stop” status), upon the completion of the edit recording in Step S209.

Then, by receiving the notification of “stop” status, the edit instructing device 32 obtains a negative determination result indicating that the recorder is not in the play state in Step S108, and thus the processing procedure is terminated.

Specifically, in the assemble editing using the edit instructing device 32, a cue-up operation corresponding to the processing of Step S109 and thereafter is supposed to be automatically performed after the edit recording is completed, as described with reference to FIG. 2. However, assemble editing using a recorder compatible with random access recording media results in a situation where playback is interrupted at a time point when edit recording is completed, and thus the recorder fails to proceed to the subsequent processing.

In the assemble editing which has been commonly performed, it is not possible to set an in-point of additional video data at the head of a magnetic tape recording medium or at a position within a section from the head of the magnetic tape recording medium to a position forward from the head by a distance corresponding to a predetermined playback time. This is because to start recording of the additional video data from the in-point with high precision, run-up is necessary to ensure a stable running state of the magnetic tape recording medium by the time when the in-point is reached, as described above.

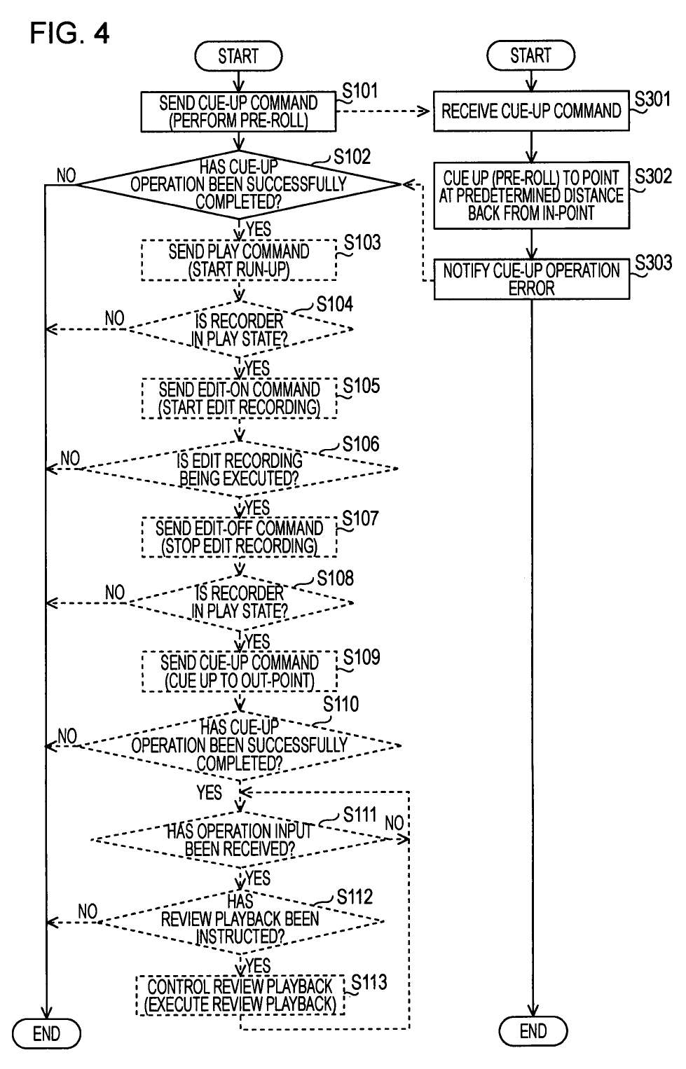

Further, when assemble editing is performed using a random access recording medium, it is difficult for a recorder having only a simple correspondence function to perform edit recording (additional recording) by setting an in point at a logical head position of a recording area of the recording medium, at the head position of video data file or the like of an editing source, or at a position within a section from the head of the recording area (or the file head) to a position forward from the head by a distance corresponding to a predetermined playback time. This will be described using an example of a processing procedure illustrated in FIG. 4.

As shown in FIG. 4, when the edit instructing device 32 sends a recorder a cue-up command at Step S101, the recorder receives the cue-up command at Step S301 and executes a pre-roll operation at Step S302.

An in-point specified in this processing is assumed to be set at the head of a file stored in the recording medium as an editing source data (or the logical head position of the recording area) or at a position within a section from the file head (or from the logical head position of the recording area) to a position forward from the head by a distance corresponding to a predetermined playback time (pre-roll time). In a pre-roll operation in this example, an address of a data position at a point backward from a data position of the in-point by a distance corresponding to a playback time necessary for the pre-roll operation (i.e., address of the pre-roll position) is located at a position back from the file head (or from the logical head position of the recording area). That is, if the address of the pre-roll position is calculated, an address that does not exist is obtained. This results in an error in the processing of Step S302, and thus the recorder sends the edit instructing device 32 information indicating occurrence of an error as a response to the cue-up command at Step S303.

By receiving the response indicating an error in the cue-up operation, the edit instructing device 32 obtains a negative determination result in Step S102. At this time, the edit instructing device 32 discontinues the processing for assemble editing. That is, an error occurs in the pre-roll operation, which results in the interruption of the assemble editing.

In general, assemble editing is a technique in which dubbing is sequentially performed on one master recording medium. Thus, it is unlikely that it is necessary to start dubbing of additional video data from the head of source data to be edited (i.e., the head of a magnetic tape recording medium, the logical head position of a recording area of a random access recording media, a head position of a file, etc.). However, if the additional video data can be dubbed with an in-point located at the head of the source data to be edited, the degree of freedom in editing is increased. Thus, such a capability can be utilized.

Accordingly, the disc recording/playback apparatus 10, serving as a recorder compatible with random access recording media, is configured such that the processing procedure of assemble editing is not interrupted when edit recording is completed as in the case described above using FIG. 3 when assemble editing is executed in accordance with control performed by the edit instructing device 32. This configuration is intended to allow a user to perform assemble editing by controlling the disc recording/playback apparatus 10 according to the present embodiment using the edit instructing device 32, in the similar manner to the case of a common recorder for magnetic tape recording media.

In view of the above, attempt is made to overcome the above situation, as described above using FIG. 4, where it is not possible to set an in-point at a logical head position of a recording area of a recording medium, at a head position of a file, or at a position within a section from the head position (logical head position or file head position) to a position forward from the head position by a predetermined distance corresponding to a predetermined playback time (pre-roll time).

This attempt will be described below.

As described above with reference to FIG. 3, a program which allows the control unit 20 to carry out command interpretation and processing corresponding to the content of commands is installed in the disc recording/playback apparatus 10. This program is compatible with hardware corresponding to a physical layer of a communication standard with which the edit instructing device 32 complies and with a hierarchical layer higher than the physical layer.

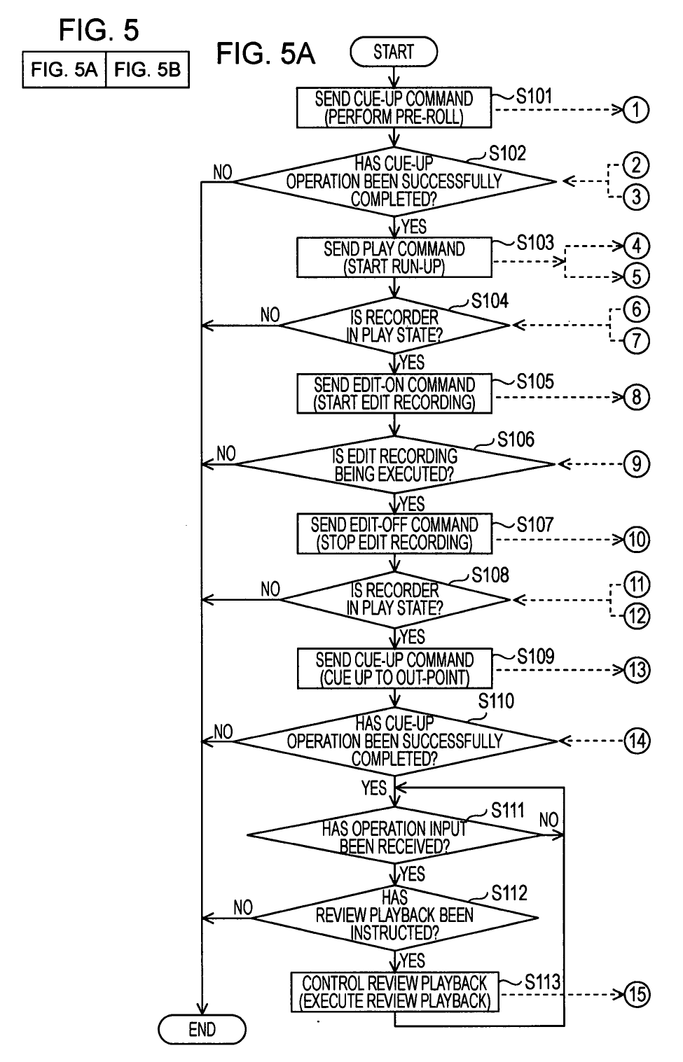

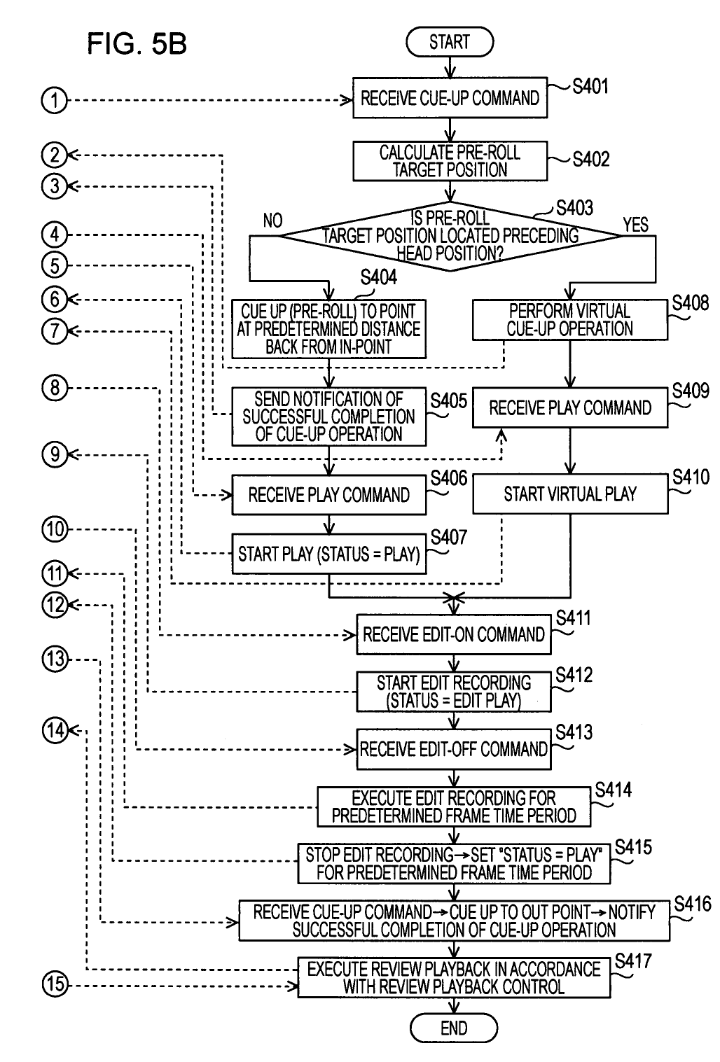

Thus, in the disc recording/playback apparatus 10, the control unit 20 executes a processing procedure illustrated in FIGS. 5A and 5B in accordance with the above program. A flowchart in FIG. 5A illustrates the same processing procedure as that illustrated in FIG. 2, for example, which is performed by the edit instructing device 32 for automatically executing assemble editing. A flowchart in FIG. 5A illustrates an example of a processing procedure which is performed by the disc recording/playback apparatus 10 according to the present embodiment in response the processing performed by the edit instructing device 32.

At Step S101, the edit instructing device 32 sends the disc recording/playback apparatus 10 a cue-up command for pre-roll. The disc recording/playback apparatus 10 receives the cue-up command at Step S401, and the processing procedure proceeds to Step S402.

At Step S402, the disc recording/playback apparatus 10 calculates a pre-roll target position. In this processing, the disc recording/playback apparatus 10 calculates a data position (address) of an editing source file which is to be accessed by pre-roll, using an in-point (data position set as an additional recording (dubbing) start position in the editing source file which has been recorded on an optical disc), which has been set for the assemble editing prior to the execution of the processing procedure, and a playback time corresponding to the pre-roll operation (pre-roll time). That is, a data position (address) at a distance corresponding to a data section corresponding to the pre-roll time, back from the data position as the in-point is calculated and set as the pre-roll target position.

Then, at Step S403, the disc recording/playback apparatus 10 determines if the calculated pre-roll target position is located back or forward from the head position of the editing source file recorded on the optical disc (or the logical head position of the recordable area of the optical disc 11).

If it is determined that the pre-roll target position is located forward from the head position of the editing source file, the disc recording/playback apparatus 10 obtains a negative determination result, and the processing proceeds to Step S404.

The processing from Step S404 to Step S407 is similar to the processing from Step S202 to Step S205 performed by the recorder as described using FIG. 3.

If is determined that the calculated pre-roll target position is located back from the head position of the editing source file, i.e., no pre-roll target position substantially exists, the processing from Step S408 to Step S410 is executed.

At Step S408, the disc recording/playback apparatus 10 performs a virtual cue-up operation.

In this virtual cue-up operation, the data position (address) which has been calculated as the pre-roll target position in Step S402 is set as a virtual data position (address) representing the position of the editing source file after pre-roll. In a real cue-up operation performed on, for example, a magnetic tape recording medium, a recorder sends the edit instructing device 32 a time code of the editing source data in response to rewinding of the magnetic tape recording medium. However, in Step S408, the disc recording/playback apparatus 10 generates a virtual time code and sends the virtual time code to the edit instructing device 32. When a time code corresponding to the virtual pre-roll target position is output, the disc recording/playback apparatus 10 generates a virtual response indicating the successful completion of the cue-up operation and sends the virtual response to the edit instructing device 32.

As a result of the execution of the processing of Step S408, the edit instructing device 32 receives the time code and the response indicating the successful cue-up operation in Step S102. Then, at Step S103, the edit instructing device 32 transmits a play command for run-up.

At Step S409, the disc recording/playback apparatus 10 receives the play command transmitted from the edit instructing device 32, and the processing procedure proceeds to Step S410.

At Step S410, the disc recording/playback apparatus 10 initiates the following virtual play operation in response to the play command.

First, assuming that playback is initiated from the virtual data position as the pre-roll target position, the disc recording/playback apparatus 10 sends the edit instructing device 32 a time code corresponding to the progress of the playback. At this time, since, in reality, the disc recording/playback apparatus 10 does not execute recording/playback on the optical disc 11, the disc recording/playback apparatus 10 is supposed to send a notification of “stop” status. However, in this process, the disc recording/playback apparatus 10 sends a virtual notification of “play” status to the edit instructing device 32. Then, at timing when the time code reaches a value representing the head position of the editing source file, the disc recording/playback apparatus 10 actually starts playback of the optical disc 11 from the head position of the editing source file. After actually starting the playback of the optical disc 11, the disc recording/playback apparatus 10 sends the edit instructing device 32 an actual time code obtained in accordance with the progress of the playback and an actual notification of “play” status obtained in accordance with the actual playback operation.

As a result of the execution of the processing of Step S410, the edit instructing device 32 receives the time code being incremented in accordance with the progress of the run-up and the notification (response) of “play” status. Thus, the edit instructing device 32 obtains a positive determination result in Step S104, and thus the processing procedure proceeds to Step S105.

At Step S411, the disc recording/playback apparatus 10 receives an edit-on command transmitted in Step S105 at a timing when the playback for run-up is completed and an in-point is reached. In response to the edit-on command, the disc recording/playback apparatus 10 initiates edit recording at Step S412. Specifically, data overwriting for recording additional video data from the data position set as the in-point in the editing source file is started.

As a result of the execution of the processing of Step S411 and Step S412 after the execution of the processing of Step S408 to Step S410, recording of the additional video data is started from the in-point which is set at the head position of the editing source file or at a position within a section from the head position of the editing source file to the data position at a distance corresponding to the pre-roll time forward from the head position of the editing source file. Note that it is not necessary to perform an operation such as run-up on random access recording media before recording is started as in the case of magnetic tape recording media. To perform recording/playback on the optical disc 11 as a random access recording medium, it is necessary to drive the optical disc 11 to rotate, and thus stable rotation of the optical disc 11 is necessary. This may seem to be associated with stable running necessary for recording/playback on magnetic tape recording media. However, data recording/playback using a magnetic tape recording medium is performed by applying a magnetic field to the running magnetic tape recording medium using a head which physically touches the tape. On the other hand, data recording/playback using an optical disc recording medium is performed by irradiating laser light from an optical head onto the rotating optical disc through the air therebetween. Accordingly, for the optical disc, data recording can be started/stopped by controlling irradiation of laser light from the optical head while the optical disc is stably rotated. That is, in the case of a random access recording medium including a disc recording medium, it is possible to perform data recording as overwriting from a file head position (logical head position of a recording area). By utilizing this fact, in this embodiment, the processing from Step S408 to Step S410 is performed so that the in-point can be set at the head position of the editing source file or at a position within a section from the head position of the editing source file to the position at a distance corresponding to the pre-roll time forward from the head position of the editing source file, as described above.

Then, once edit recording is started in Step S412 as described above, the disc recording/playback apparatus 10 sends the edit instructing device 32 status notification information indicating that the edit recording is in progress (“edit-play” status). Thus, the disc recording/playback apparatus 10 obtains a positive determination result in Step S106 and transmits an edit-off command at a timing when the out-point is reached at Step S107.

At Step S413, the recorder receives the edit-off command and executes the processing of Step S414 and Step S415 in response to the edit-off command.

At Step S414, the disc recording/playback apparatus 10 does not stop the recording of the additional video signals immediately after the reception of the edit-off command but continues the recording of the additional video signals for a time period corresponding to a predetermined frame period (for example, one frame period). During this time period, the disc recording/playback apparatus 10 sends the edit instructing device 32 a notification of “edit play” status in accordance with the actually continued recording. When the predetermined frame period elapses, the disc recording/playback apparatus 10 stops the recording of the additional video signal (edit recording) at Step S415. As a result, the actual status of the disc recording/playback apparatus 10 is “stop” status. However, in Step S415, the disc recording/playback apparatus 10 generates a virtual notification of “play” status for a predetermined frame period (for example, one frame) immediately after stopping the edit recording and sends the virtual notification to the edit instructing device 32.

Thus, even after receiving the edit-off command, the disc recording/playback apparatus 10 still transmits the “edit-play” status according to the actual operation of the edit recording for a predetermined frame period in Step S414. Then, after stopping the recording of the additional video signals, the disc recording/playback apparatus 10 sends the virtual notification of “play” status in Step S415.

This indicates that the edit instructing device 32 receives status notification information indicating status other than “stop” status over the time period in which the processing of Step S414 and S415 is performed (for example, a time period corresponding to two frame periods). Thus, the edit instructing device 32 obtains a positive determination result in Step S108 and thus the processing procedure proceeds to Step S109. That is, the assemble editing is not interrupted even when the edit recording is completed, and thus the disc recording/playback apparatus 10 can proceed to a subsequent operation for the assemble editing such as a cue-up operation to the out-point and review playback.

In FIG. 5, processing of Step S416 and Step S417 is indicated as processing to be performed by the disc recording/playback apparatus 10 in accordance with the processing of Step S109 and the subsequent processing steps performed by the edit instructing device 32.

At Step s416, the disc recording/playback apparatus 10 receives the cue-up command transmitted from the edit instructing device 32 in Step S109 and executes a cue-up operation to an out-point (i.e., access to a recording position corresponding to the out-point) in response to the cue-up command. Further, at Step S416, when the cue-up operation is completed, the disc recording/playback apparatus 10 sends the edit instructing device 32 a response indicating the successful completion of the cue-up operation.

At Step S417, the disc recording/playback apparatus 10 receives various commands from the edit instructing device 32 for controlling review playback and performs operations corresponding to the received commands. As a result of the operations, review playback is executed.

Both the processing of Step S414 and the processing of Step S415 cause the edit instructing device 32 to recognize that the disc recording/playback apparatus 10 is in “play” status after edit recording is stopped. In the following, the purpose of each of the processing of Step S414 and Step S415 will be described.

The processing of Step S414 is intended to save a margin so that a file end position is set at a position forward from the actual out-point by actually performing edit recording. For example, if edit recording on a random access recording medium such as the optical disc 11 is terminated simply in response to an edit-off command, the edit instructing device 32 may recognize during subsequent review playback that there is no actual data to be played back at the out-point (i.e., the file end position), which results in a error. Thus, by saving the margin at Step S414, such an error can be avoided.

However, if the length of the margin exceeds a length corresponding to a certain frame period, the edit recording is significantly prolonged even after the out-point is reached. This may degrade the reliability of the disc recording/playback apparatus 10. Thus, a time period during which the margin is recorded in Step S414 is set to a time period which may not degrade the reliability (for example, one frame period). For the remaining time period in which the notification of “play” status still needs to be transmitted, a virtual notification of “play” status is transmitted in Step S415.

Accordingly, for example, there may be a situation where only the continuation of edit recording for a predetermined time period (Step S414) is performed and the transmission of the virtual notification of “play” status (Step S415) is omitted, depending on the length of the time period in which the notification of “play” status needs to be transmitted and the length of the time period necessary for recording the margin. In contrast, only the transmission of the virtual notification of “play” status is performed for a time period without the continuation of the edit recording (recording of margin), as long as, for example, review playback can be reliably performed without error.

The processing procedure performed by the disc recording/playback apparatus 10 according to the present embodiment illustrated in FIG. 5B may be realized by causing a CPU as a hardware component of the control unit 20 to load a program stored in a storage unit such as a ROM or a flash memory provided in the control unit 20.

Such a program may be stored in the storage unit in the control unit 20 during manufacturing or may be stored in a removable storage medium and then installed to the disc recording/playback apparatus 10 from the removable storage medium. It is also possible that the program is stored in a storage unit in a server or the like on a network. In such a case, the disc recording/playback apparatus 10 is provided with network connectivity to access the server and download the program for installation.

In addition, the present invention is not limited to the embodiments described above. For example, in the above embodiments, an optical disc recording medium is implemented in the recording/playback apparatus compatible with random access recording media. However, other types of disc recording medium such as hard disk devices may also be implemented. Further, the present invention is also applicable to a recording/playback apparatus compatible with other types of recording media than disc recording media, such as semiconductor storage devices including flash memories.

Moreover, the present invention may be applied to other linear editing schemes than assemble editing such as insert editing.

It should be understood by those skilled in the art that various modifications, combinations, sub-combinations and alterations may occur depending on design requirements and other factors insofar as they are within the scope of the appended claims or the equivalents thereof.

What is claimed is:

1. A recording/playback apparatus comprising:
a recording/playback unit configured to perform data recording/playback on a recording medium permitting random access;
a command inputting unit configured to input a series of predetermined commands transmitted from an external edit instructing device so that a result of data editing performed according to a predetermined editing scheme is obtained as recorded data on the storage medium
a corresponding processing executing unit configured to execute processing including at least control of data recording/playback performed by the recording/playback unit, so that an operation corresponding to a command input to the command inputting unit is performed; and
a control unit configured to control the corresponding processing executing unit in response to an edit recording stop command included in the series of predetermined commands, the edit recording stop command instructing stopping of edit recording in which the recording/playback unit records data to be added to an editing material on the storage medium, so that the edit instructing device recognizes that the recording/playback unit is at least not in a stop state during a predetermined response period which begins after input of the edit recording stop command and so that data recording as the edit recording being performed by the recording/playback unit is stopped at a predetermined timing within the predetermined response period.

2. The recording/playback apparatus of claim 1, wherein the control unit controls the recording/playback unit so that the data recording as the edit recording is continued during the response period.

3. The recording/playback apparatus of claim 1, wherein the control unit transmits state notification information to the edit instructing device during the response period, the state notification information indicating that the recording/playback unit is in a predetermined state other than a stop state, at a timing after the data recording as the edit recording performed by the recording/playback unit is stopped.

4. The recording/playback apparatus of claim 1, wherein the control unit controls the recording/playback unit so that the data recording as the edit recording is continued and then stopped during a predetermined first period of the response period and sends the edit instructing device state notification information indicating that the recording/playback unit is in a predetermined state other than the stop state during a predetermined second period of the response period.

5. A recording/playback method comprising the steps of:
performing data recording/playback on a storage medium permitting random access;
inputting a series of predetermined commands transmitted from an external edit instructing device so that a result of data editing performed according to a predetermined editing scheme is obtained as recorded data on the storage medium;
executing processing including at least control of data recording/playback so that operations corresponding to the commands are performed; and
performing control in response to an edit recording stop command included in the series of predetermined commands, the edit recording stop command instructing stopping of edit recording in which data to be added to an editing material is recorded on the storage medium, so that the edit instructing device recognizes that the performing data recording/playback has at least not been stopped during a predetermined response period which begins after input of the edit recording stop command and so that data recording as the edit recording is stopped at a predetermined timing within the predetermined respond period.

6. A program configured to cause a recording/playback apparatus to execute a recording/playback method comprising the steps of:
performing data recording/playback on a storage medium permitting random access;
inputting a series of predetermined commands transmitted from an external edit instructing device so that a result of data editing performed according to a predetermined editing scheme is obtained as recorded data on the storage medium;
executing processing including at least control of data recording/playback so that operations corresponding to the commands are performed; and
performing control in response to an edit recording stop command included in the series of predetermined commands, the edit recording stop command instructing stopping of edit recording in which data to be added to an editing material is recorded on the storage medium, so that the edit instructing device recognizes that the performing data recording/playback has at least not been stopped during a predetermined response period which begins after input of the edit recording stop command and so that data recording as the edit recording is stopped at a predetermined timing within the predetermined respond period.
